(19) United States
(12) Patent Application Publication
(10) Pub. No.: US 2026/0338651 A1
(43) Pub. Date: Oct. 29, 2026

(54) METHOD FOR CONCENTRATING AT LEAST ONE ANTHROPOGENIC TARGET SUBSTANCE IN A SAMPLE LIQUID

(71) Applicant: IST Innuscreen GmbH, Berlin (DE)

(72) Inventors: Timo Hillebrand, Hönow (DE); Elmara Graser, Berlin (DE); Wiebke Jacobi, Falkensee (DE)

(21) Appl. No.: 19/117,848

(22) PCT Filed: Sep. 13, 2023
(86) PCT No.: PCT/EP2023/075071

§ 371 Date: Apr. 2, 2025

(30) Foreign Application Priority Data
Oct. 6, 2022 (DE) 10 2022 125 783.5

(51) Int. Cl. G01N 1/40; G01N 15/00; G01N 15/075

(52) U.S. Cl. CPC G01N 1/405; G01N 15/075; G01N 2001/4088; G01N 2015/0053

(57) ABSTRACT

A method for concentration of at least one anthropogenic target substance in a sample liquid, which anthropogenic target substance consists of particles and/or particulates with an average particle or particulate size in the nanometer range, includes: adding a superabsorber to an initial volume of liquid of the sample liquid or adding the volume of liquid to the superabsorber; incubating, over a first period, the mixture obtained by mixing the superabsorber and the volume of liquid; and removing a first sample of the liquid portion of the mixture present after incubation.

The invention relates to a method for concentrating at least one anthropogenic target substance in a sample liquid, which anthropogenic target substance consists of particles and/or particulates with an average particle or particulate size in the nanometer range. Nanoparticles and nanoparticulates are playing an increasingly important role in our lives. This concerns, for example, the use, and in this context also the production, of these particles and particulates for a variety of applications in the pharmaceutical industry (for example in connection with encapsulated mRNA active ingredients), food technology or the electrical engineering or electronics industry (for example in connection with quantum dots).

Due to their small size and the associated changes in physical characteristics, nanoparticles and/or nanoparticulates can be used to transport drugs to desired organs since they can penetrate the blood-brain barrier (e.g., suitable for use in pharmaceutics) and the skin (e.g., suitable for use in the cosmetics industry). Nanoparticles and/or nanoparticulates are also used for diagnostic applications, for example for color detection in rapid tests based on colloidal gold. They also stabilize food and thereby ensure longer shelf lives.

Nanoparticles and/or nanoparticulates are almost exclusively anthropogenic substances. This means that the nanoparticles and/or nanoparticulates have been produced by humans through industrial, commercial and municipal processes and not, for example, by biological organisms. Another aspect of nanoparticles and/or nanoparticulates therefore concerns the pollution of our planet since nanoparticles and/or nanoparticulates are often difficult to biodegrade. Nanoparticles and/or nanoparticulates arise, for example, from waste from the plastics industry or through the partial decomposition of plastic waste in nature (so-called secondary nanoplastics). The worldwide pollution of the environment with waste from the plastic industry is a global problem. Nanoplastic waste with particles and/or particulates smaller than 1 μm enters the ecosystem unhindered and is often not stopped by sewage treatment plants. The damage caused by micro- and nanoplastics includes the accumulation of the particulates in the tissues of aquatic organisms. They also reach us humans through polluted water and food chains. The accumulation of hydrophobic persistent organic pollutants (POPs) in the environment means an increasing additional burden on marine life and humans. Nanoparticles and/or nanoparticulates made of plastic or plastics are particularly dangerous because they can pass through the cell membrane and influence cell metabolic processes.

The currently used collection and detection methods are only suitable for macro- and microplastics, but not for nanoplastics. To assess environmental pollution, plastic waste is collected from surface water, for example. This makes use of the fact that about 98% of plastic particles have a lower density than water. The plastic particles are collected using large nets with a mesh size of about 0.3 mm, which are pulled over the water surface by a boat. The collected sediment is separated by size by sieving. The plastic particles are then suspended and filtered according to size. Other approaches are based on the filtration of large volumes of water or air. The concentration of plastic particles in different waters is estimated at approximately 1.5×10⁻⁵ to 0.11 g/m³.

However, in all these approaches, the plastic components <0.33 mm (i.e., parts of the nanoparticles and nanoparticulates in the micrometer range and all nanoparticles and nanoparticulates in the nanometer range) are either lost or remain in the filter cycle.

Micro- and nanoplastic waste is detected using spectroscopic methods (e.g., Raman or infrared spectroscopy), thermoanalytical methods (e.g., dynamic differential scanning calorimetry (DSC)), using gas chromatography mass spectrometer (GC/MS), using microscopy (optical, fluorescence-based) or also using fluorescence-based flow cytometry. This reveals the problem that detection is very complicated due to the low concentration of nanoplastics. A novel and simple concentration method would also be desirable for these fields of application.

The object of the invention is to provide a simple, rapid and universally usable method for concentrating at least one anthropogenic target substance in a sample liquid.

This object is achieved in a surprisingly simple and universally applicable manner by means of the method defined in claim 1, the use according to claim 21, and the kit according to claim 24. Advantageous embodiments are listed in the dependent claims.

The solution is based on the use of so-called superabsorbers, with which any aqueous sample liquid can be processed in order to concentrate the nanoparticles and/or nanoparticulates contained in the sample liquid.

Superabsorbers (superabsorbent polymers, SAP) are plastics which are capable of absorbing a multiple of their own weight in polar liquids. These are mainly water or aqueous solutions. When the liquid is absorbed, the superabsorber swells and forms a hydrogel. Hydrogels can be formed by all cross-linked polymers which are polar (e.g., polyacrylamide, polyvinylpyrrolidone, amylopectin, gelatin, cellulose). Usually, however, a copolymer of acrylic acid (propene acid, H2C=CH—COOH) or sodium acrylate (sodium salt of acrylic acid, H2C=CH—COONa) on the one hand and acrylamide on the other hand is used, wherein the ratio of the two monomers to one another can vary. In addition, a so-called core cross-linker (CXL) is added to the monomer solution and connects the long-chain polymer molecules formed with each other in places by chemical bridges, also known as cross-linking. The polymer is water-insoluble because of these bridges. This so-called base polymer is possibly subjected to a so-called surface cross-linking (SXL). A further chemical is applied here to the surface of the particles which, by heating, links a second network only to the outer layer of the grain. This shell supports the swollen gel in order to also hold together under external loading (movement, pressure).

The product is traditionally used, for example, as white granules having particle sizes of 100-1000 μm. It is mainly used in baby diapers, sanitary napkins, incontinence care, bandages and, in small amounts, also in cable sheathings for deep-sea cables. Further areas of application are so-called gel beds, gel-forming extinguishing agents in firefighting, as a mechanical stabilizer for cut flowers in a vase or as additive for plant soil in order to save on water on an ongoing basis. However, due to its better environmental compatibility, potassium-neutralized acrylic acid is used here. In the form of spherical particles, the use of superabsorbers as a toy is known, with designations such as “aqua beads” or “water beads”. These are superabsorbers which are commercially available in the form of spheres of variable sizes (submillimeters to centimeters).

The invention was based on the following unexpected observation: A water sample was mixed with fluorescent nanoparticles with an average particle or particulate size of 30 nm. After adding commercially available water pearl beads and after an incubation period during which the beads swelled to several times their original volume, it was shown that the nanoparticulates were not absorbed by the superabsorbers, but were concentrated in the remaining residual liquid.

This observation shows that by using superabsorbers, and in particular superabsorbers that are commercially available in the form of so-called water pearl beads, a wide variety of nanoparticulates can be easily and quickly concentrated in a liquid sample. The concentrated particulates can then be detected more easily because the concentration results in a higher target concentration.

With the method and means according to the invention, it is thereby possible to concentrate nanoparticulates of a wide range of compositions for detection reactions efficiently, easily and quickly.

On the basis of this observation, it was possible to achieve the object of the invention. The method according to the invention for concentrating at least one anthropogenic target substance in a sample liquid comprises:
adding a superabsorber to an initial volume of liquid of the sample liquid or adding the volume of liquid to the superabsorber,
incubating the mixture obtained by mixing the superabsorber and the volume of liquid over a first period, and
removing a first sample of the liquid portion of the mixture present after incubation.

“Anthropogenic substances” are substances that are not created by nature but by humans, for example through industrial, commercial or municipal processes. They include, for example, plastics, but also pesticides, pharmaceuticals, personal care products and industrial chemicals as well as their degradation products and metabolites. Biomolecules that are produced, for example, by microorganisms (e.g., enzymes, DNA/RNA fragments, etc.) and have similar sizes in the nanometer range do not fall under the particles and/or particulates of anthropogenic substances mentioned in this application.

In the method according to the invention indicated above, the first sample, which is removed from the liquid portion of the mixture of liquid and superabsorber, which is present after incubation, can be the entire remaining liquid portion. However, it is also possible to remove only a partial volume of the given liquid portion as the first sample.

The first sample can be used directly for a subsequent analysis, for example by means of a spectroscopic method. However, it can also be further concentrated in a cascading process in one or more additional stages, for example by readdition of a superabsorber and/or readdition to a superabsorber and reincubation, or by means of a conventional method for concentrating target substances, for example by one of the methods specified at the outset. If only a part of the liquid portion is removed as the first sample, the target substance in the liquid portion of the mixture remaining after the sample removal can be further concentrated by reincubation over a second period. Both variants of the method can be performed out repeatedly, so that a higher concentration of the target substance is obtained at each stage of the cascading concentration.

It is advantageous, in a first stage, to reduce the initial sample volume by means of the method according to the invention using a superabsorber, and in a subsequent second stage to perform further concentration of the target substance by means of a conventional concentration technique, for example filtration, ultrafiltration, precipitation reaction, ultracentrifugation or coating by means of the method described in EP 2283026 B1. These known techniques can be used significantly more efficiently than in more strongly diluted solutions in already reduced sample volumes. The method according to the invention is thereby suitable for significantly simplifying known methods for concentrating nanoparticles or nanoparticulates for large-volume sample liquids and/or sample liquids containing only low concentrations of the target substance.

As mentioned, in an advantageous embodiment, after removal of the first sample, the method can comprise a further concentration of the target substance in the removed first sample.

The further concentration of the target substance in the removed first sample can be performed by means of a filtration, ultrafiltration or precipitation reaction technique.

Alternatively, however, the further concentration of the target substance in the removed first sample can also be performed again, and optionally in a cascading manner, once or multiple times by performing the following method steps:
adding a superabsorber to the first sample or adding the first sample to the superabsorber,
incubating, over a second period, the mixture obtained by mixing the superabsorber (5) and the first sample, and
removing a concentrated first sample of the liquid portion of the mixture present after incubation.

As described above in the first stage of the cascade, the concentrated first sample that is removed from the liquid portion remaining after incubation can comprise the entire volume of the liquid portion. Alternatively, the concentrated first sample can be a partial volume of the remaining liquid portion.

The target substance can be further concentrated in the concentrated first sample or in a further concentrated first sample obtained by further concentration, in particular by means of a superabsorber, by means of a filtration, ultrafiltration or precipitation reaction. This is advantageous if the volume of the concentrated first sample only corresponds to a few milliliters, e. g., 1 to 10 mL.

As already mentioned, the method according to the invention for concentrating the target substance can comprise the following further steps after removal of the first sample from the remaining liquid portion of the mixture from the originally used volume of liquid and the superabsorber:
optionally cascading, and singly or multiply repeated, reconcentrating the target substance in the liquid portion of the mixture remaining after removal of the first sample, by
   reincubating, over a third period, the mixture remaining after removal of the first sample from the remaining liquid portion and the superabsorber; and
   removing a second sample of the liquid portion of the mixture present after reincubation.

As a result of the reincubation, the volume of the liquid portion is further reduced, and accordingly the target substance is further concentrated in the liquid portion. The concentration of the target substance is determined, inter alia, by the prespecifiable duration of the third period and the conditions prevailing during the incubation.

In the method according to the invention, the initially used volume of liquid can contain a polar liquid, in particular as a main constituent. In an advantageous embodiment of the method according to the invention, the volume of liquid can contain a polar solvent, in particular as a main constituent. For example, the volume of liquid can consist of a polar solvent, at a mass fraction of at least 50%. The polar liquid or the polar solvent can be water, for example.

The target substance is a nanoparticle and/or nanoparticulate. Such a substance consists of an anthropogenic substance, in particular of at least one natural polymer, of at least one biocompatible synthetic polymer, of an inorganic material, or of an organic material.

As mentioned, in an advantageous embodiment, the superabsorber can be a plastic or comprise a plastic which absorbs a proportion of the volume of liquid, for example a polar solvent contained in the volume of liquid, such as water, to form a gel or hydrogel. Advantageously, the plastic is selected such that it no substantially does not absorb nanoparticulates. This is the case, for example, in the above-mentioned superabsorbers made of the mentioned polymer and/or copolymer materials, for example, the commercially available water beads, etc.

The superabsorber can be used in the form of particles, for example as a powder, as granules or in the form of geometric bodies, in particular beads (spherical particles). It can thus be added to the volume of liquid and/or the first sample in the form of such particles, or the volume of liquid and/or the first sample can be added to the superabsorber in this form. The particles or beads can have a diameter between 100 to 5000 μm.

Advantageously, the superabsorber is commercially available superabsorber spheres—for example, superabsorber beads available under the names “aqua beads”, “water beads”, “water pearls”, “aqua pearls”, “hydro beads”, and “gel beads”.

In an advantageous method embodiment, the volume of the liquid portion remaining after the step of incubating, and thus the concentration of the target substance in the remaining liquid portion, is controlled by the length of the period or the periods of incubation, by the size and number of the superabsorber particles or superabsorber spheres added to the initially used volume of liquid of the sample liquid and/or of the first sample, and/or by the temperature prevailing during the incubation.

It can be provided that the sample liquid constitutes a filtrate or a centrifugation supernatant. Before concentration, one or more separation steps are performed to remove further components from the sample.

One embodiment of the method provides that the sample liquid constitutes an environmental sample. An environmental sample is taken from the environment, for example from bodies of water, such as lakes or rivers. But sediment or gas samples, for example, which are then mixed with a liquid, are also referred to as environmental samples.

The invention further comprises a method for detecting an anthropogenic target substance in a sample liquid, comprising:
concentrating the sample liquid using the concentration method according to the invention using the superabsorbers, and
performing a physical detection method for the qualitative and/or quantitative determination of the anthropogenic target substance.

The physical detection method serves to determine whether certain nanoparticles and/or nanoparticulates are present in the concentrated sample or how high their concentration is. In the initial liquid volume, these would not be detectable by the physical detection method because their concentration is too low. A microscope is used for qualitative and/or quantitative determination. In this case, for example, the nanoparticles and/or nanoparticulates are counted in a section of defined size. Alternatively, a fluorescence measurement method or a spectroscopic measurement method is used. For this purpose, the nanoparticles and/or nanoparticulates must contain a fluorescent dye which is added in particular before concentration.

The invention also comprises a use of a superabsorber for concentration, performed once or multiple times in a cascading manner, of the anthropogenic target substance in a liquid sample. The liquid sample can contain a polar liquid, in particular water, wherein the superabsorber is designed to absorb the polar liquid, for example water, or at least a portion of the polar liquid, thereby forming a hydrogel. The superabsorber can be formed from the materials described above and can be used in the above-described embodiments as granules or, particularly preferably in the form of beads, in particular commercially available water pearls, water beads, or aqua beads.

The cascading concentration can comprise several stages. After each stage, a sample can be removed for analysis and the process of concentration can be continued, or the sample concentrated in at least one stage after incubation of the sample with the superabsorber or a portion of the sample can subsequently be further concentrated using other known methods.

The invention also comprises a kit for performing the method described above. The kit can comprise, for example, one or more containers with a pre-placed superabsorber, into which a user can then add an initial volume of liquid for concentration or a sample already concentrated in a first stage.

The liquid concentrated according to the described method and/or according to the described use, i.e., the liquid portion present after incubation, or a sample removed from the concentrated liquid can be supplied manually or automatically to a laboratory instrument for further treatment or analysis. In one possible embodiment of the method or the use, such a liquid or sample of the liquid can be added to a cartridge, in particular a microfluidic cartridge, of an automatic analysis device for the automated performance of a detection of the target substance by means of a physical detection method for the qualitative and/or quantitative determination of the anthropogenic target substance. This can take place manually or in an automated manner.

The invention is explained in more detail below with reference to the figures and some exemplary embodiments. These examples do not represent any limitation of the means and methods according to the invention. In the figures:

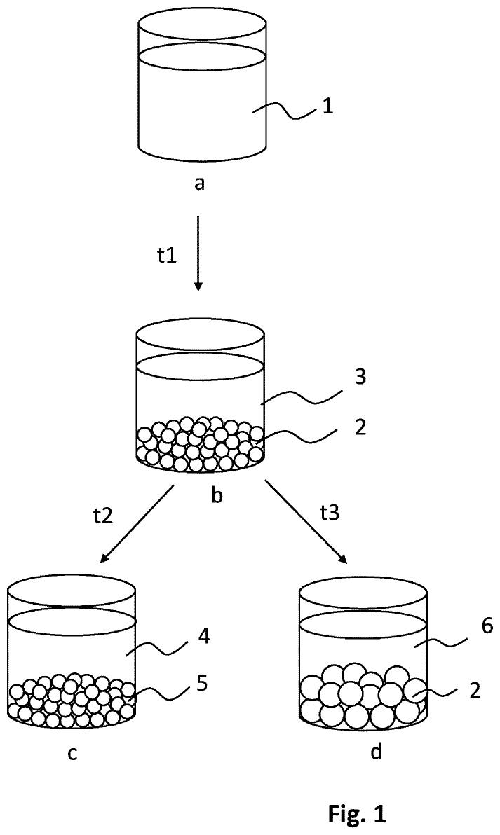

FIG. 1 is a schematic representation of the cascading concentration of a target substance in a liquid;
a) liquid before the addition of a superabsorber;
b) liquid after the addition of a superabsorber and incubating the mixture;
c) first sample removed from the mixture after adding a further superabsorber and incubating the mixture;
d) remaining mixture of liquid and superabsorber, optionally after removal of the first sample and after reincubation;

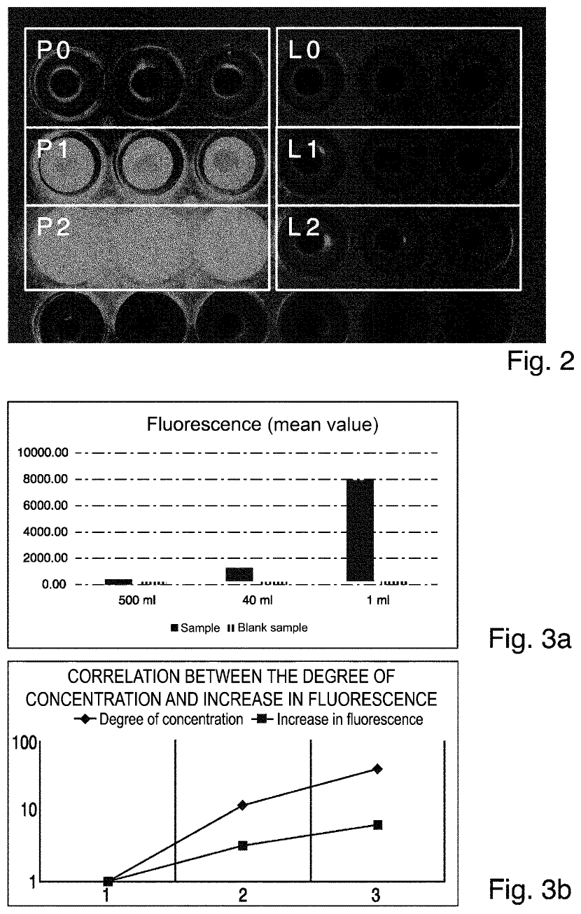

FIG. 2 is a representation of samples and blank samples, some of which were obtained by means of the concentration according to the invention and exposed to UV light; and

FIG. 3 shows evaluations of the measurement data:
a) a graphical representation of the mean values of the measured values in a bar chart;
b) a correlation between the degree of concentration and the increase in fluorescence of the samples.

The use of superabsorbers for concentrating a target substance, in particular, nanoparticles and/or nanoparticulates, in a polar liquid as solvent, for example, water, for concentrating the target substance in the liquid is very simple and universally usable. A suitable method is described briefly with reference to FIGS. 1a and b as follows:
1. Addition of a superabsorber 2 to a volume of a liquid 1, in particular an aqueous liquid, or alternatively: addition of the liquid 1 to a superabsorber 2;
2. Incubation of the mixture of the liquid 1 and the superabsorber 2 over a first period t1 for concentrating (reduction in volume) the liquid portion 3 of the mixture; and then
3. Transferring at least one first sample 4 of the liquid portion 3 of the mixture into a new vessel as a sample for further processing.

Further processing can, for example, be a quantitative and/or qualitative detection of the target substance in the liquid. The detection is performed, for example, using a spectroscopic or microscopic method.

The degree of concentration and the speed of this process can be controlled very precisely by means of the type of superabsorber used, by means of the amount thereof used, or by means of the incubation time and/or the incubation temperature.

With the method, the problem of processing low-concentrated samples can thus be easily solved for further processing of the target substances of interest, in particular nanoparticles and/or nanoparticulates, or their detection. The method shown in FIGS. 1a and b works without devices, such as ultra-centrifuges, expensive ultrafiltration membranes, complex processes, such as PEG precipitation, or generally precipitation reactions for concentrating nucleic acids, etc. In addition, the method can be used universally in relation to the type of nanoparticles and/or nanoparticulates. A further advantage is that the superabsorbers are non-toxic and safe and often also biodegradable. The method according to the invention makes it possible to greatly simplify the investigation of low-concentrated nanoparticles and/or nanoparticulates.

In the case of large-volume and/or strongly diluted liquids which contain the nanoparticles and/or nanoparticulates at a very low concentration, a cascading concentration of the target substance is possible. For example, in a first stage, the described method can be used with the above-mentioned steps 1-3 in order to concentrate the target substance. In a second stage, the volume of the first sample 4 can be reduced for reconcentration of the target substance. This can be done either by means of a conventional filtration or precipitation method, or other conventional methods. Alternatively, however, reconcentration of the target substance in the first sample 4 can also take place, as shown in FIG. 1c, by adding fresh superabsorber 5 to the first sample 4, or transferring the first sample 4 to a new superabsorber 5, and reincubating over a second period t2. Additionally or alternatively, the liquid portion 6 remaining in a mixture with the superabsorber 2 after removal of the first sample 4 can be further reduced by incubating the mixture over a third period t3, as shown in FIG. 1d. This leads to further swelling with an increase in volume of the spheres consisting of the superabsorber 2, and to a further volume reduction in the liquid portion 6, which is accompanied by an increase in concentration of the target substance in the liquid portion 6.

In both alternative method paths, further cascading concentration stages can follow.

An exemplary embodiment of the invention will be described in detail below.

### Exemplary Embodiment: Concentration of Rhodamine B-Filled Latex Nanoparticles (Ø 25.8 nm) in a Water Sample

The latex nanoparticles were provided by the Fraunhofer Institute for Applied Polymer Research. The concentration of latex particles in the stock solution was 2.02 M %. The particles were added to a 500 ml water sample, and a 1:10,000 dilution was produced.

Subsequently, a superabsorber in the form of commercially available “water beads” was added to the water sample. During the concentration by the absorption of water into the water beads, samples P0, P1, P2 were taken at different times, which each corresponded to different concentrations.

The samples are divided into blank samples L0, L1, L2 for control (without latex nanoparticles) and samples P0, P1, P2 that contain the latex nanoparticles. Specifically, the samples are as follows:
Blank sample L0: Ultrapure water without latex particles (500 ml)
Blank sample L1: Concentration of 500 ml ultrapure water to 40 ml ultrapure water
Blank sample L2: Further concentration of L1 to 1 ml ultrapure water
Sample P0: 1:10,000 dilution of the latex particle stock solution in 500 ml ultrapure water
Sample P1: Concentration of 500 ml ultrapure water to 40 ml ultrapure water
Sample P2: Further concentration of P1 to 1 ml ultrapure water

The particles in the respective samples were detected by measuring the fluorescence of the dye contained in the latex nanoparticles.

FIG. 1 shows a qualitative detection of the latex nanoparticles. For this purpose, the respective samples P0, P1, P2 and the blank samples L0, L1, L2 were each transferred in triplicate to a UV-transparent measuring plate. The measuring plate with the samples was then exposed to UV light. Exposure to UV light causes fluorescence excitation in the samples in which there are latex particles. No fluorescence is seen in the blank samples L0, L1, L2, and an increasing fluorescence is seen with increasing concentration of the samples P0, P1, P2, which contain the latex nanoparticles.

Table 1 shows a quantitative measurement of the respective samples using a fluorescence measuring device. The measurements are performed by exciting the samples P0, P1, P2 and the blank samples L0, L1, L2 (each in triplicate) at an emission of 559 nm. While the values of the blank samples L0, L1, L2 remain consistently low with concentration, the values of the samples P0, P1, P2 that contain the nanoparticles increase proportionally to the degree of concentration.

TABLE 1

| | Fluorescence measured | | Fluorescence measured |
|---|---|---|---|
| Sample | values | Sample | values |
| P0 | 432.92/344.75/414.06 | L0 | 193.38/168.69/269.60 |
| P1 | 1282.19/1214.20/1292.55 | L1 | 220.20/187.81/257.12 |
| P2 | 7694.19/7995.08/8099.97 | L2 | 237.47/257.65/234.28 |

In FIG. 2, the measured values listed in Table 1 are graphically displayed or evaluated. In FIG. 2a), the mean values of the respective measured values of a sample are shown as a bar chart. In FIG. 2b), a correlation between the degree of concentration and the increase in fluorescence of samples P0 (“1”), P1 (“2”) and P2 (“3”) containing nanoparticles is shown.

The data from the experiment clearly show that the fluorescent latex nanoparticles of the sample do not diffuse into the utilized superabsorber (“water beads”) but remain in the external solution, and the concentration of the latex nanoparticles thereby increases continuously and corresponding to the degree of concentration.

### LIST OF REFERENCE SIGNS

1 Initial fluid volume
2, 5 Superabsorber
3, 6 Liquid part of the mixture
4 First sample
t1, t2, t3 Periods
L0, L1, L2 Blank samples
P0, P1, P2 Samples

1-24. (canceled)

25. A method for concentrating at least one anthropogenic target substance in a sample liquid, which target substance consists of particles and/or particulates with an average particle and/or particulate size in a nanometer range, the method comprising:
adding a first superabsorber to an initial liquid volume of the sample liquid, or adding the initial liquid volume to the first superabsorber, to produce a first mixture;
incubating the first mixture over a first period, wherein after incubation a liquid portion and the first superabsorber remain; and
removing a first sample of the liquid portion of first mixture.

26. The method according to claim 25, further comprising further concentrating the target substance in the removed first sample.

27. The method according to claim 26, wherein the further concentration of the target substance in the removed first sample is performed using a filtration, ultrafiltration, or precipitation reaction technique.

28. The method according to claim 26, wherein the further concentration of the target substance in the removed first sample is performed by:
adding a second superabsorber to the first sample, or adding the first sample to the second superabsorber, to produce a second mixture;
incubating the second mixture over a second period, wherein after incubation a concentrated liquid portion and the second superabsorber remain; and
removing a concentrated first sample of the concentrated liquid portion of the second mixture.

29. The method according to claim 28, wherein the target substance is further concentrated in the concentrated first sample, or in a further concentrated first sample obtained by a further concentrating, by further incubating with the second superabsorber or by a filtration, ultrafiltration, or precipitation reaction.

30. The method according to claim 25, further comprising reconcentrating the target substance in a remaining mixture, which remaining mixture consists of the first superabsorber and a remaining liquid portion of the first mixture remaining after removal of the first sample, by:
re-incubating the remaining mixture over a third period, wherein after incubation a further concentrated liquid portion and the first superabsorber remain; and
removing a second sample of the further concentrated liquid portion of the remaining mixture.

31. The method according to claim 25, wherein the liquid volume contains a polar liquid.

32. The method according to claim 31, wherein the polar liquid is water.

33. The method according to claim 31, wherein the particles and/or particulates of the target substance consist of at least one natural polymer, of at least one biocompatible synthetic polymer, of an inorganic material, or of an organic material.

33. The method according to claim 25, wherein the first superabsorber comprises a plastic material, which absorbs a portion of the liquid volume such that a hydrogel is formed.

34. The method according to claim 33, wherein the plastic material does not absorb essentially any particles and/or particulates contained in the target substance.

35. The method according to claim 28, wherein the first superabsorber and the second superabsorber are the same material.

36. The method according to claim 25, wherein the first superabsorber is in the form of particles, including powder, granules, spheres, or other geometric bodies.

37. The method according to claim 25, wherein the first superabsorber is used in the form of commercially available “aqua beads”, “water beads”, “water pearls”, “aqua pearls”, “hydro beads”, or “gel beads”.

38. The method according to claim 28, wherein a volume of the liquid portion, of the concentrated liquid portion, and/or of the further concentrated liquid portion remaining after incubation is controlled by at least one of:
the length of the first period and/or the second period, respectively;
a type and/or amount of the first superabsorber and/or the second superabsorber, respectively; and
a temperature of the first and/or second mixture, respectively, present during incubation.

39. The method according to claim 38, wherein the first superabsorber and/or the second superabsorber are in the form of particles, including powder, granules, spheres, or other geometric bodies, and
wherein the volume of the liquid portion and/or the concentrated liquid portion remaining after incubation is controlled by the size and/or number of the particles.

40. The method according to claim 25, wherein the sample liquid constitutes a filtrate or a centrifugation supernatant.

41. The method according to claim 25, wherein the sample liquid constitutes an environmental sample.

42. A method for detecting an anthropogenic target substance in a sample liquid, the method comprising:
concentrating the target substance in the sample liquid by the method according to claim 25; and
performing a physical detection method capable of a qualitative and/or quantitative determination of the target substance.

43. The method according to claim 42, wherein the determination occurs under a microscope.

44. The method according to claim 42, wherein the physical detection method is a fluorescence measurement method or a spectroscopic measurement method.

45. The method according to claim 42, wherein the physical detection method is a UV and/or fluorescence measurement method, and
wherein a fluorescent dye is added to the sample liquid before concentrating the target substance in the sample liquid.

46. A method for concentrating at least one target substance in a liquid sample, the method comprising:
using a superabsorber to concentrate the at least one target substance in the liquid sample, wherein the concentrating is performed once or multiple times in a cascading manner.

47. The method according to claim 46, wherein particles and/or particulates of the at least one target substance consist of at least one natural polymer, of at least one biocompatible synthetic polymer, of an inorganic material, or of an organic material.

48. The method according to claim 47, wherein the liquid sample contains a polar liquid, and wherein the superabsorber is embodied to absorb the polar liquid such that a hydrogel is formed.

49. A kit for performing the method according to claim 25, the kit comprising:
one or more containers with a pre-placed superabsorber therein, which are configured to enable a user to add the initial liquid volume for concentrating or a sample already concentrated in a first stage.

50. The kit according to claim 49, wherein in at least one of the one or more containers, the superabsorber therein is a different material than a respective superabsorber in at least one of the remaining one or more containers.
